(19) United States
(12) Patent Application Publication
(10) Pub. No.: US 2005/0131859 A1
(43) Pub. Date: Jun. 16, 2005

(54) Method and system for standard bookmark classification of web sites

(75) Inventor: Jin Li, Toronto (CA)

Correspondence Address: Jerry W. Herndon;IBM Corporation, T81/503, 3039 Cornwallis Road, Research Triangle Park, NC, 27709, US

(73) Assignee: International Business Machines Corporation, Armonk, NY (US)

(21) Appl. No.: 11/001,362

(22) Filed: Dec. 1, 2004

(30) Foreign Application Priority Data
Dec. 3, 2003 (CA) 2,452,269

(51) Int. Cl. G06F 7/00

(52) U.S. Cl. 707/1

(57) ABSTRACT

There is disclosed a technique for indexing a web page utilizing a standard classification system. In an embodiment, the technique comprises selecting a classification code from the standard classification system for each web page. The web page is then tagged with a classification tag containing the selected classification code. The classification tag may be embedded directly in the web page. Alternatively, the classification tag may be external to the web page, and may be logically associated with the web page. The classification code in the classification tag may be used to automatically classify each web page, according to the standard classification system. Examples of a suitable standard classification system include NAICS, NACE, and ISIC, among others.

### BACKGROUND OF THE INVENTION

The present invention relates generally to data processing systems, and in particular, to a method, system and computer readable media containing executable code for bookmarking web pages on the World Wide Web.

The World Wide Web, or WWW, is a hypertext information and communication system used on the worldwide network of computers commonly known as the Internet. WWW operates according to a client-server model using a HyperText Transfer Protocol (“HTTP”). HTTP provides user access to files formatted using standard page description languages, including meta-language formats such as HyperText Markup Language (“HTML”), Extensible Markup Language (“XML”), Extensible HyperText Markup Language (“XHTML”), and the like.

As known, HTML is an application of Standard Generalized Markup Language (“SGML”), which is an international standard (ISO 8879) for text information processing. Files that are accessed using HTML may be provided in many different formats including text, graphics, images, sound, and video. HTML provides basic document formatting and allows a web developer to specify links to web pages defined by HTML over the WWW. XML is also based on SGML, but XML provides a way of representing data and information in a more flexible format than HTML. Like HTML, XML allows a web developer to specify links to web pages defined by XML over the WWW. XHTML is a reformulation of HTML in XML conforming format, but is less commonly used than the other two formats.

As known, links to web pages may be specified using an addressing scheme commonly known as the Uniform Resource Locator (“URL”). By specifying a web page by its URL, an end-user is able to access the web page from an end-user system with a connection to the WWW.

Entering a URL for a web page may require the input of a long string of characters and may be difficult to memorize. To assist the end-user, a bookmarking facility is typically provided in web browsers on the end-user system, allowing the end-user to bookmark a URL for a web page being viewed. The end-user is then able to later access the web page by selecting the bookmarked URL from the web browser on the end-user system.

For the purposes of the present discussion, “bookmarking a URL” is substantially equivalent to “bookmarking a web page” by its URL. It will be appreciated, however, that a web page may be accessed via multiple URLs.

Some known bookmarking systems and methods allow the end-user to create the desired subject categories (e.g. by creating subject category folders) and to manually classify each web page (e.g. by placing the web page's URL in a suitable subject category folder) according to the end-user's preferences. Other known bookmarking systems and methods attempt to classify web pages based on an analysis of the content of the web pages being visited, or based on an analysis of some other criteria, such as the end-user's actions in viewing the web pages. However, ultimately, the end-user's input is still required to classify the web page.

An alternative technique for bookmarking and classifying web pages is desirable.

### SUMMARY OF THE INVENTION

There is provided a method, system and computer readable media containing executable code for bookmarking and classifying web pages, utilizing a standard classification system.

In an embodiment, each web page is classified according to a selected standard classification system and tagged with a classification tag. When a web page is accessed from a web browser on an end-user system, the web browser reads the web page's classification tag, bookmarks the web page's URL, and classifies the web page according to the classification tag.

By way of example, web pages may be classified according to a standard classification system known as the North American Industry Classification System (“NAICS”). For further information on NAICS, the reader is directed to the URL “www.naics.com”. Corresponding international equivalents to the NAICS may also be selected, including the General Industrial Classification of Economic Activities within the European Communities (NACE), and the International Standard Industrial Classification (ISIC). Virtually any other standard classification system suitable for classifying web pages may be selected.

In an aspect of the invention, there is provided a method of indexing a web page utilizing a standard classification system, comprising:

(i) for each web page, selecting a classification code from the standard classification system;

(ii) tagging the web page with a classification tag containing the selected classification code, the classification tag being configured to be readable during bookmarking of the web page.

In an embodiment, the method further comprises embedding the classification tag in the web page.

In an embodiment, the embedding comprises inserting a classification tag line.

In an embodiment, the web page is formatted using a page description language, and the embedding comprises inserting a searchable string in the page description language.

In an embodiment, the method further comprises, at (i), accessing a selectable list of available classification codes in the standard classification system.

In an embodiment, the method further comprises, before (i), selecting from one of a plurality of standard classification systems.

In an embodiment, the standard classification system is one of the North American Industry Classification Standard (NAICS), the General Industrial Classification of Economic Activities within the European Communities (NACE), and the International Standard Industrial Classification (ISIC).

In an embodiment the classification tag is external to the web page, and the tagging comprises associating the external classification tag to the web page.

In an embodiment, the tagging comprises logically associating a classification tag to the web page's URL, such that accessing the web page via the URL facilitates access to the associated classification tag.

In an embodiment, the method further comprises storing the web page URL and the associated classification tag in a relational database.

In another aspect of the invention there is provided a system comprising a processor and computer readable memory, the memory storing code for classifying a web page in accordance with a standard classification system, the code being configured to:

(a) for each web page, facilitate selection of a classification code from the standard classification system;

(b) tag the web page with a classification tag containing the selected classification code, the classification tag being configured to be readable during bookmarking of the web page.

In an embodiment, the code is further configured to embed the classification tag in the web page.

In an embodiment, the code is configured to insert a classification tag line.

In an embodiment, the web page is formatted using a page description language, and the code is configured to insert a searchable string in the page description language.

In an embodiment, the code is further configured to access, at (a), a selectable list of available classification codes in the standard classification system.

In an embodiment, the code is further configured to select, before (a), from one of a plurality of available standard classification systems.

In an embodiment, the standard classification system is one of the North American Industry Classification Standard (NAICS), the General Industrial Classification of Economic Activities within the European Communities (NACE), and the International Standard Industrial Classification (ISIC).

In an embodiment, the classification tag is external to the web page, and the code is further configured to associate the external classification tag to the web page.

In an embodiment, the code is further configured to logically associate a classification tag to the web page's URL, such that accessing the web page via the URL also facilitates access to the associated classification tag.

In an embodiment, the code is further configured to store the web page URL and the associated classification tag in a relational database.

In another aspect of the invention, there is provided a computer readable medium containing computer executable code for classifying a web page in accordance with a standard classification system, the computer executable code including:

(a) code for selecting, for each web page, a classification code from the standard classification system;

(b) code for tagging the web page with a classification tag containing the selected classification code, the classification tag being configured to be readable during bookmarking of the web page.

In an embodiment, the computer executable code furthers comprises code for embedding the classification tag in the web page.

In an embodiment, the code for embedding comprises code for inserting a classification tag line.

In an embodiment, the web page is formatted using a page description language, and the code for embedding comprises code for inserting a searchable string in the page description language.

In an embodiment, the computer executable code further comprises, at (a), code for accessing a selectable list of available classification codes in the standard classification system.

In an embodiment, the computer executable code further comprises code, executable before (a), for selecting from one of a plurality of standard classification systems.

In an embodiment, the standard classification system is one of the North American Industry Classification Standard (NAICS), the General Industrial Classification of Economic Activities within the European Communities (NACE), and the International Standard Industrial Classification (ISIC).

In an embodiment, the classification tag is external to the web page, and the code for tagging comprises code for associating the classification tag to the web page.

In an embodiment, the code for tagging comprises code for logically associating a classification tag to a web page URL, such that accessing the web page via the URL also facilitates access to the associated classification tag.

In an embodiment, the computer executable code further comprises code for storing the web page URL and the associated classification tag in a relational database.

The foregoing and other aspects of the invention will be apparent from the following more particular descriptions of exemplary embodiments of the invention.

### BRIEF DESCRIPTION OF THE DRAWINGS

In the figures which illustrate exemplary embodiments of the invention:

FIG. 1 is a schematic block diagram of a computer network which may provide an operating environment for exemplary embodiments of the invention.

FIG. 2 is a schematic block diagram of an end-user system which may be found in the computer network of FIG. 1.

FIG. 3 is a schematic block diagram of a web developer system which may be found in the computer network of FIG. 1.

FIG. 4 is a schematic block diagram of a web server which may be found in the computer network of FIG. 1.

FIG. 5 is a schematic block diagram showing the interaction between applications running on the end-user system, the web developer system, and the web server.

FIG. 6A is a schematic block diagram illustrating web pages which may be stored in the web server of FIG. 4 and accessed from the end-user system of FIG. 2.

FIG. 6B is a schematic block diagram with example URLs for the web pages in FIG. 6A.

FIG. 7 is a schematic representation of the web pages of FIG. 5 each having a classification tag, in accordance with an exemplary embodiment of the invention.

FIG. 8 is a schematic flow chart of a method of classifying a web page, in accordance with an exemplary embodiment of the invention.

FIG. 9 is a schematic flow chart of a method of bookmarking and classifying web page URLs, in accordance with an exemplary embodiment of the invention.

FIG. 10 is a schematic block diagram illustrating an alternative embodiment of the invention.

### DETAILED DESCRIPTION OF EXEMPLARY EMBODIMENTS

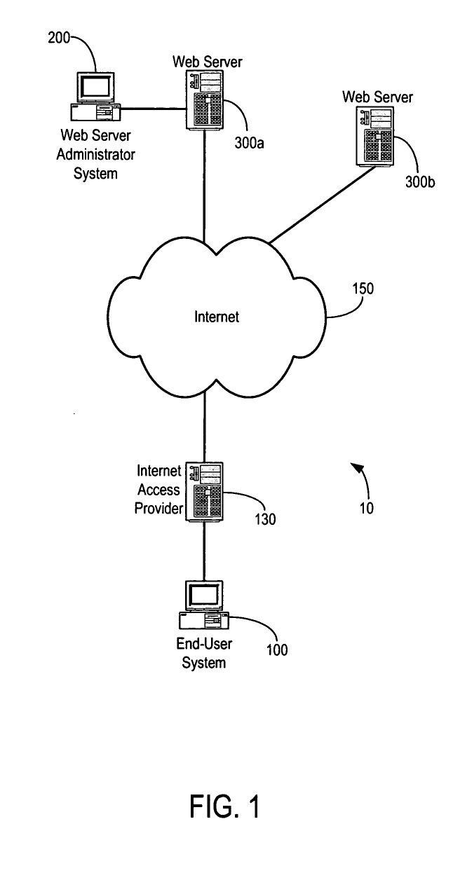

FIG. 1 shows an illustrative computer network 10 which may provide an operating environment for exemplary embodiments of the invention. An end-user system 100 is connected to an Internet access provider 130 to access the Internet 150. Web servers 300a and 300b are also connected to the Internet 150 and may be accessed by the end-user system 100 in known manner. A web developer system 200 is connected to web server 300a to develop web pages on the web server 300a. The web developer system 200 may also access web server 300b via the Internet 150 and transfer web pages to web server 300b in a known manner. (Hereinafter, web servers 300a and 300b are collectively “web server 300”.)

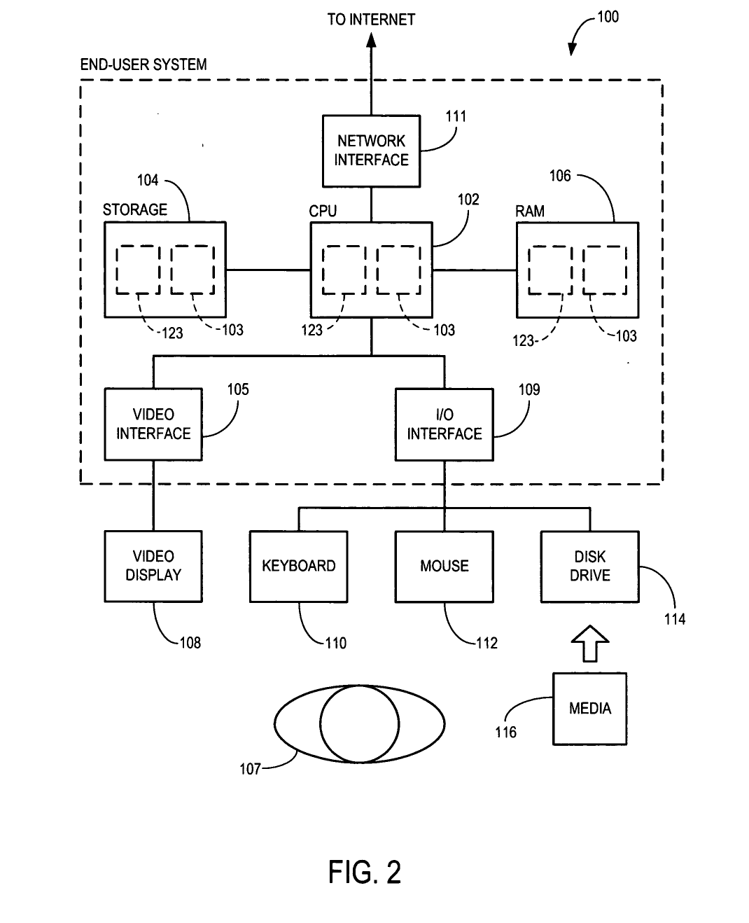

Now referring to FIG. 2, shown is an exemplary end-user system 100 which may be found in the computer network 10 of FIG. 1. As shown, the end-user system 100 may include a central processing unit (“CPU”) 102 connected to a storage unit 104 and to a random access memory (“RAM”) 106. The CPU 102 may run an operating system 103 and execute one or more application programs 123. One of the application programs 123 may be a web browser application program. The operating system 103 and application program 123 may be stored in storage unit 104 and loaded into RAM 106 as required. An end-user 107 may interact with the end-user system 100 using a video display 108 connected by a video interface 105, and various input/output (“I/O”) devices such as a keyboard 110, mouse 112 and disk drive 114 connected by an I/O interface 109. The disk drive 114 may be configured to accept computer readable media 116. The end-user system 100 is network enabled via a network interface 111. As shown, network interface 111 allows the end-user system 100 to access the Internet 150, through the Internet access provider 130 of FIG. 1.

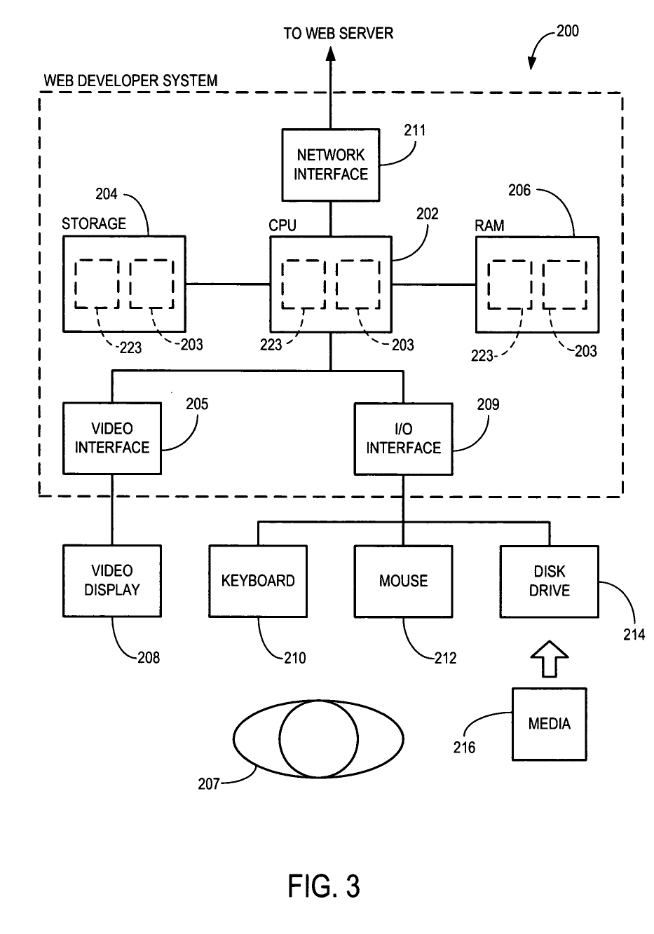

Now referring to FIG. 3, shown is a corresponding web developer system 200 which may be found in the computer network of FIG. 1. As will be apparent, the web developer system 200 may be substantially similar to the end-user system 100 of FIG. 2, with a CPU 202, storage 204, and RAM 206 to run an operating system 203 and a web development application program 223. The web development application program 223 may be configured to perform various tasks as described in detail further below. The web development application program 223 may also access a standard classification code selection system (not shown) for selecting a suitable code, as described further below. A web developer 207 may interact with the web developer system 200 using a video display 208 connected by a video interface 205, and various I/O devices 210, 212, 214 connected by an I/O interface 209. The disk drive 214 may be configured to accept computer readable media 216. The web developer system 200 is network enabled via a network interface 211.

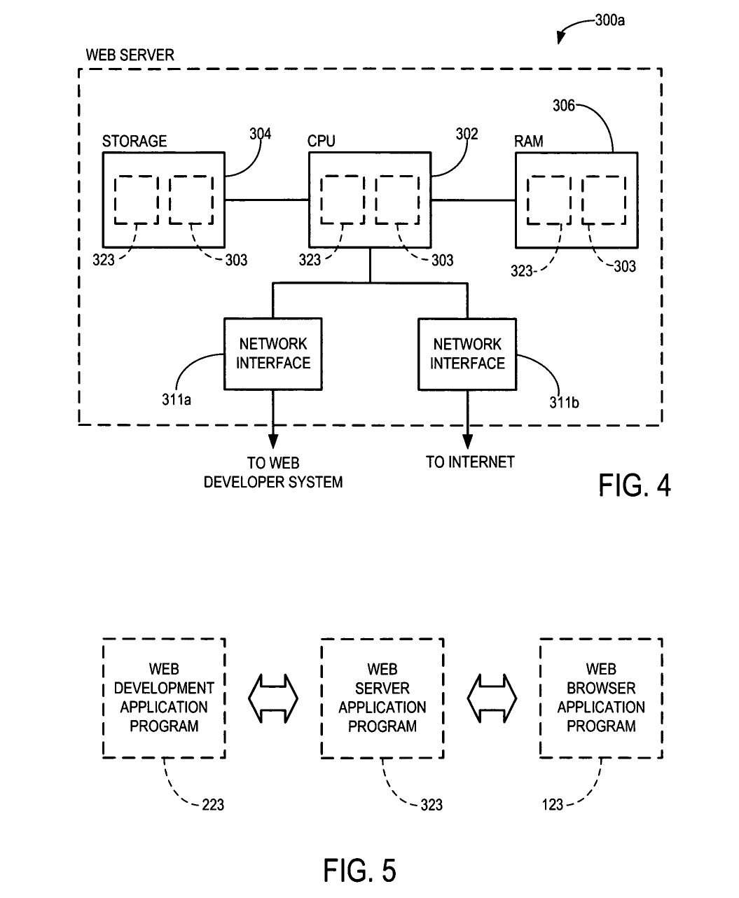

Now referring to FIG. 4, shown is a schematic representation of the web server 300 of FIG. 1. As shown, the web server 300 has CPU 302, storage 304, and RAM 306 to run an operating system 303 and one or more web server application programs 323. The web server application program 323 may be configured to allow various tasks to be performed, as described below. Web server 300 is connected to the web developer system 200 via a first network interface 311a, and to the Internet 150 via a second network interface 111b.

It will be appreciated that each of the end-user system 100, the web developer system 200 and the web server 300 described above are merely illustrative, and are not meant to be limiting in terms of the type of systems that may provide a suitable operating environment for practicing various embodiments of the invention.

Now referring to FIG. 5, shown is a schematic block diagram of the interaction between applications running on the end-user system 100, the web developer system 200, and the web server 300. More specifically, web development application program 223 is used to develop web pages and configured to interact with the web server application 323 to store the web pages on web server 300. The web server application program 323 is also configured to interact with the web browser application program 123 running on the end-user system 100 to allow the end-user 107 to access various web pages stored in storage 304 on the web server 300.

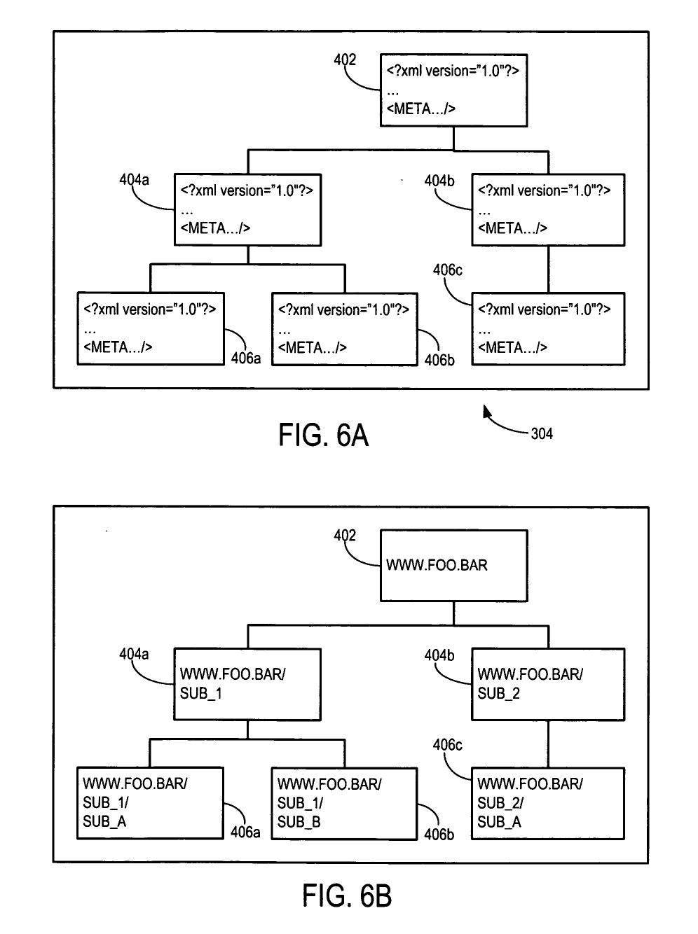

Now referring to FIG. 6A, shown is an illustrative example of a logical tree structure of web pages stored in storage 304 of web server 300. As previously discussed, these web pages may be formatted according to any one of a number of page description formats, including meta-language formats such as HTML, XML, XHTML, and the like. As shown in this illustrative example, a top level web page 402 is linked in a logical tree structure to lower level web pages 404a and 404b. Each of these lower level web pages 404a, 404b in turn are linked to other lower level web pages 406a, 406b and 406c. FIG. 6B illustrates possible URLs for the web pages in FIG. 6A. For example, web page 402 has the URL “WWW.FOO.BAR”. As shown in FIG. 6B, lower level web pages have corresponding URLs indicating a tree structure.

In an exemplary embodiment, each of the web pages 402, 404a, 404b, 406a-406c shown in FIG. 6A is tagged with a classification tag. In this illustrative example, each of these web pages are formatted in an XML format and contain a searchable string, such as a “<META . . . />” tag line, which serves as an internal classification tag.

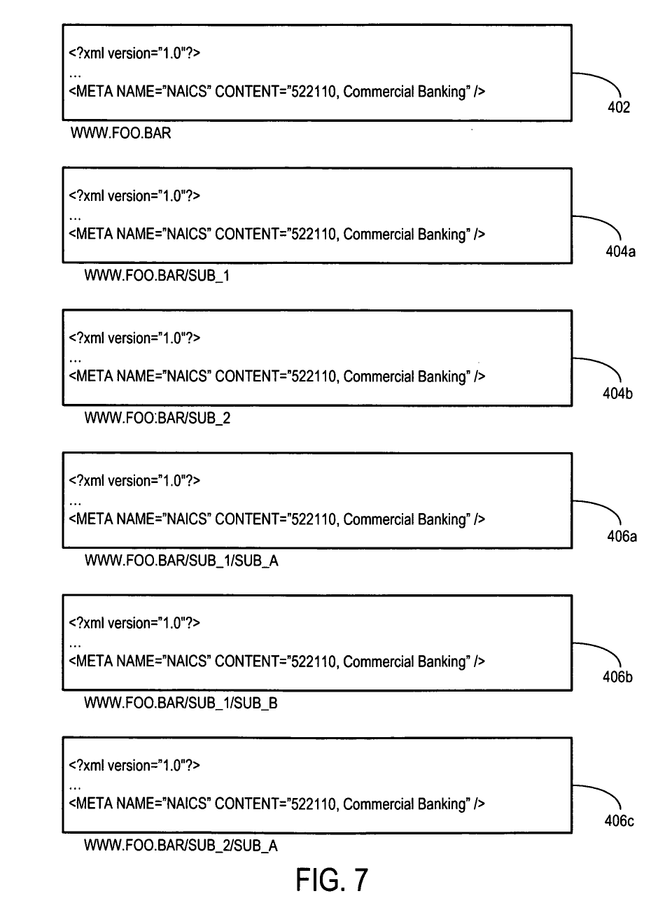

Now referring to FIG. 7, shown is an illustrative example of web pages 402, 404a, 404b, 406a-406c of FIG. 6A containing “<META . . . />” tag lines, with classification codes from the NAICS standard classification system. For example, the top level web page 402 has a “<META . . . />” tag line indicating that it has been classified as NAICS classification code “522110” for “Commercial Banking”. (The reader is again directed to the URL “www.naics.com” for further information on NAICS classification codes.) This “<META . . . />” tag line thus serves as the classification tag for web page 402.

As shown in FIG. 7, each of the other web pages 404a, 404b, 406a-406c also have a “<META . . . />” tag line. In this illustrative example, the classifications are the same, namely: <META NAME=“NAICS” CONTENT=“522110, Commercial Banking”/>. Thus, the web pages 402, 404a, 404b-406c are all classified in the same classification category “522110” for “Commercial Banking”.

In an alternative embodiment, where one or more web pages of a web site are suitable for classification in another classification code, it will be appreciated that different classification codes may be used for different web pages at the same web site. Thus, for example, a higher level web page may have a general classification code, and lower level web pages may have related sub-classification codes.

In another embodiment, where more than one classification code may apply to a web page, that web page may contain more than one classification tag. For example, in the illustrative example shown above in FIG. 7, a second “<META . . . />” tag line may be inserted into the XML code of one of the web pages. Alternatively, one such tag line may be configured to refer to multiple classification codes.

In another embodiment, a web page may be provided with classification tags for more than one classification system. For example, NAICS, NACE, and ISIC may all be used for each web page. In this way, the web page may be bookmarked and classified according to any one of NAICS, NACE, and ISIC, as selected by the end-user (e.g. end-user 107 of FIG. 2).

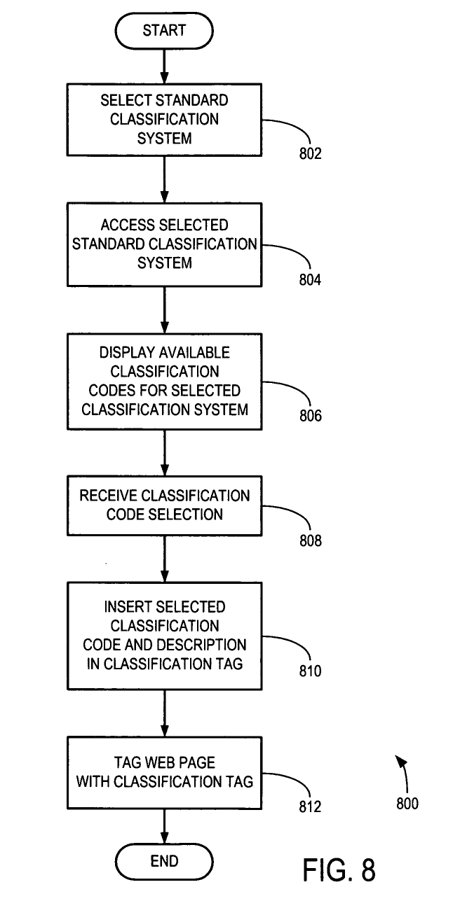

Now referring to FIG. 8, shown is an illustrative method 800 for classifying a web page (e.g. on web developer system 200 of FIG. 3). As shown, method 800 starts and, at block 802, prompts for selection of a standard classification system. Method 800 then proceeds to block 804. In order to facilitate classification of web pages (e.g. by web developer 207 of FIG. 3), method 800 may facilitate access to the standard classification system selected at block 802. At block 806, method 800 displays the classification codes available for selection by the web developer 207. Method 800 then proceeds to block 808 where method 800 receives the classification code selected by the web developer 207. Method 800 then proceeds to block 810 where the selected classification code, and optionally its associated description, is inserted into a classification tag. Method 800 then proceeds to block 812, at which the classification tag is tagged to a web page. Method 800 then ends.

In an alternative embodiment, it will be appreciated that method 800 may be readily modified such that more than one classification code is selected for a web page by the web developer 207. Also, method 800 may be repeated for a number of different standard classification systems, such that a web page may be tagged with different classification tags for each standard classification system.

In an embodiment, access to the selected standard classification system at block 804 may be to a locally cached list of codes. That is, a copy of a list of codes for a standard classification system may be maintained locally (e.g. on the web developer system 200) for the sake of efficiency. The local copy of the list of codes may be updated, from time to time, so that it corresponds to the most recent version of the standard classification system.

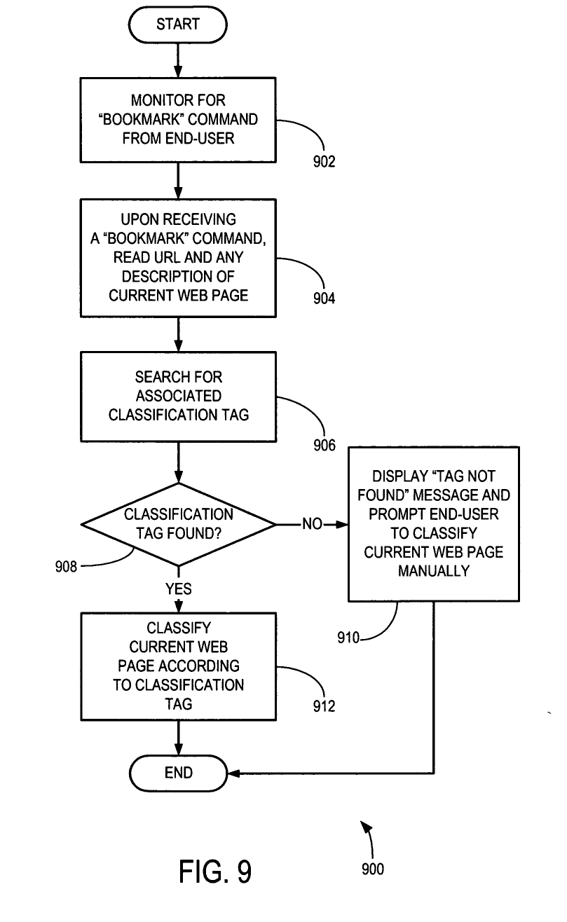

Now referring to FIG. 9, shown is an illustrative method 900 for bookmarking and classifying a web page in accordance with an exemplary embodiment of the present invention. As shown, method 900 starts and, at block 902, during browsing of a web page by an end-user (e.g. end-user 107 of FIG. 2), monitors for an end-user command to bookmark the web page. Upon receiving the bookmark command, method 900 proceeds to block 904 where the URL of the web page to be bookmarked is read. Optionally, a web page description may also be read. Method 900 then proceeds to block 906 where method 800 searches for a classification tag tagged to the web page. If there are multiple standard classification systems being used, it will be appreciated that this search at block 906 will look for classification tags for a specific standard classification system selected by the end-user. In an embodiment, the search may be for a text-string within the web page XML code. For example, if the end-user selects NAICS as the standard classification system, the classification tag search may look for each <META . . . > tag containing the string “NAICS”. In an alternative embodiment, the classification tag may be external to the web page, and the search may be conducted on any such external classification tags.

Method 900 then proceeds to decision block 908 where, if a classification tag is found, method 900 proceeds to block 912. At block 912, the classification tag for the current web page is read to extract the classification code to be used to bookmark and classify the web page. Otherwise, if a tag is not found, method 900 proceeds to block 910, where an appropriate “TAG NOT FOUND” message may be displayed to the end-user, and the end-user may be prompted to classify and bookmark the web page manually, if desired. Method 900 then ends.

Although various exemplary embodiments of the invention have been described above, it will be appreciated by those skilled in the art that variations and modifications may be made.

Thus, in an embodiment, a classification code title or description may be used as the name of a bookmark subject folder, and all web pages having the same clarification code may have their URLs stored in the same folder.

In another embodiment, web pages associated with more than one classification code may have their URLs stored in more than one subject folder, each subject folder having a name corresponding to a classification code title or description.

In another embodiment, the end-user may be provided with an option to confirm that a web page should be classified according to its classification code tag. If the end user is not satisfied with the default classification, as assigned by the web developer for example, the end-user can reclassify the web page by manually overriding the default classification.

In another embodiment, a “reset” feature may be provided in the bookmarking facility so that the end-user can initiate a search of each bookmarked web page to obtain its updated classification code, if any.

In another embodiment, an end-user may choose from a number of standard classification systems selectable from the web browser application program (e.g. web browser application program 123 of FIG. 5). This may provide the end-user with greater flexibility in the manner in which web pages are automatically bookmarked. For example, the end-user may select a standard classification system based on the end-user's geographic region, or based on a particular type of classification system used in an industry of interest to the end-user.

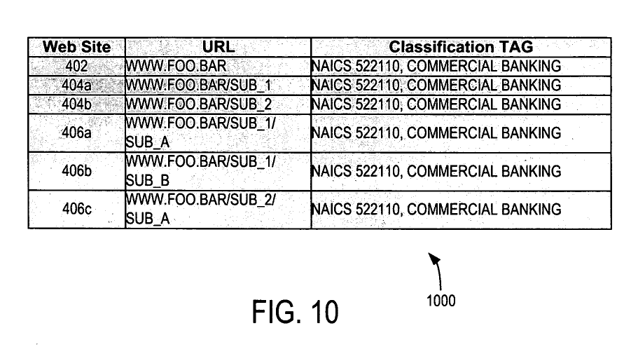

In another embodiment, an intermediate search application may be used to conduct a search of web pages for an end-user based on one or more search terms. The intermediate search application may be, for example, a modified search engine. In an embodiment, the modified search engine may be configured to associate, with each web page URL, a classification tag from a selected standard classification system. In this alternative embodiment, the classification tag need not be stored in the web page XML, HTML, or XHTML. Rather, the classification tag may be external to, and associated with, the web page. As illustrated in FIG. 10, this association may be accomplished, for example, in a relational database 1000 used by the modified search engine. Accessing a web page URL through this modified search engine may then allow access to the associated classification tag (e.g. as in relational database 1000). This intermediate search application may thus be used to perform the classification function, subsequent to development of the web pages.

Therefore, the scope of the invention is defined by the following claims.

1. A method of indexing a web page utilizing a standard classification system, comprising:
(i) for each web page, selecting a classification code from said standard classification system;
(ii) tagging said web page with a classification tag containing said selected classification code, said classification tag being configured to be readable during bookmarking of said web page.

2. The method of claim 1, further comprising embedding said classification tag in said web page.

3. The method of claim 2, wherein said embedding comprises inserting a classification tag line.

4. The method of claim 2, wherein said web page is formatted using a page description language, and said embedding comprises inserting a searchable string in said page description language.

5. The method of claim 4, further comprising, at (i), accessing a selectable list of available classification codes in said standard classification system.

6. The method of claim 1, further comprising, before (i), selecting from one of a plurality of standard classification systems.

7. The method of claim 6, wherein said standard classification system is one of the North American Industry Classification Standard (NAICS), the General Industrial Classification of Economic Activities within the European Communities (NACE), and the International Standard Industrial Classification (ISIC).

8. The method of claim 1, wherein said classification tag is external to said web page, and said tagging comprises associating said external classification tag to said web page.

9. The method of claim 8, wherein said tagging comprises logically associating a classification tag to said web page's URL, such that accessing said web page via said URL facilitates access to said associated classification tag.

10. The method of claim 9, further comprising storing said web page URL and said associated classification tag in a relational database.

11. A system comprising a processor and computer readable memory, said memory storing code for classifying a web page in accordance with a standard classification system, said code being configured to:
(a) for each web page, facilitate selection of a classification code from said standard classification system;
(b) tag said web page with a classification tag containing said selected classification code, said classification tag being configured to be readable during bookmarking of said web page.

12. The system of claim 11, wherein said code is further configured to embed said classification tag in said web page.

13. The system of claim 12, wherein said code is configured to insert a classification tag line.

14. The system of claim 12, wherein said web page is formatted using a page description language, and said code is configured to insert a searchable string in said page description language.

15. The system of claim 14, wherein said code is further configured to access, at (a), a selectable list of available classification codes in said standard classification system.

16. The system of claim 15, wherein said code is further configured to select, before (a), from one of a plurality of available standard classification systems.

17. The system of claim 16, wherein said standard classification system is one of the North American Industry Classification Standard (NAICS), the General Industrial Classification of Economic Activities within the European Communities (NACE), and the International Standard Industrial Classification (ISIC).

18. The system of claim 11, wherein said classification tag is external to said web page, and said code is further configured to associate said external classification tag to said web page.

19. The system of claim 18, wherein said code is further configured to logically associate a classification tag to said web page's URL, such that accessing said web page via said URL also facilitates access to said associated classification tag.

20. The system of claim 19, wherein said code is further configured to store said web page URL and said associated classification tag in a relational database.

21. A computer readable medium containing computer executable code for classifying a web page in accordance with a standard classification system, said computer executable code including:
(a) code for selecting, for each web page, a classification code from said standard classification system;
(b) code for tagging said web page with a classification tag containing said selected classification code, said classification tag being configured to be readable during bookmarking of said web page.

22. The computer readable medium of claim 21, wherein said computer executable code further comprises code for embedding said classification tag in said web page.

23. The computer readable medium of claim 22, wherein said code for embedding comprises code for inserting a classification tag line.

24. The computer readable medium of claim 22, wherein said web page is formatted using a page description language, and said code for embedding comprises code for inserting a searchable string in said page description language.

25. The computer readable medium of claim 24, wherein said computer executable code further comprises, at (a), code for accessing a selectable list of available classification codes in said standard classification system.

26. The computer readable medium of claim 21, wherein said computer executable code further comprises code, executable before (a), for selecting from one of a plurality of standard classification systems.

27. The computer readable medium of claim 26, wherein said standard classification system is one of the North American Industry Classification Standard (NAICS), the General Industrial Classification of Economic Activities within the European Communities (NACE), and the International Standard Industrial Classification (ISIC).

28. The computer readable medium of claim 21, wherein said classification tag is external to said web page, and said code for tagging comprises code for associating said classification tag to said web page.

29. The computer readable medium of claim 28, wherein said code for tagging comprises code for logically associating a classification tag to a web page URL, such that accessing said web page via said URL also facilitates access to said associated classification tag.

30. The computer readable medium of claim 29, wherein said computer executable code further comprises code for storing said web page URL and said associated classification tag in a relational database.
